(19) United States
(12) Patent Application Publication
(10) Pub. No.: US 2014/0320518 A1
(43) Pub. Date: Oct. 30, 2014

(54) DISPLAY DEVICE AND DISPLAY METHOD

(71) Applicants: Tadao Morishita, Osaka-shi (JP); Ken Inada, Osaka-shi (JP)

(72) Inventors: Tadao Morishita, Osaka-shi (JP); Ken Inada, Osaka-shi (JP)

(73) Assignee: SHARP KABUSHIKI KAISHA, Osaka-shi, Osaka (JP)

(21) Appl. No.: 14/354,973

(22) PCT Filed: Sep. 10, 2012
(86) PCT No.: PCT/JP2012/073108

§ 371 Date: Apr. 29, 2014

(30) Foreign Application Priority Data
Nov. 16, 2011 (JP) 2011-251058

(51) Int. Cl. G09G 5/37; G06T 5/00

(52) U.S. Cl. CPC G09G 5/37; G06T 5/00; G09G 2320/0247
USPC 345/589

(57) ABSTRACT

A display device includes an image processing unit including a detection unit to detect a flicker pattern having a checkered pattern arrangement included in an input image that has been input; and a conversion unit to, if the detection unit detects the flicker pattern included in the input image, convert the input image into an output image that does not include the flicker pattern.

### TECHNICAL FIELD

The present invention relates to a display device and a display method.

### BACKGROUND ART

In recent years, the development research of display devices has been remarkable, and from the display devices which used CRTs that were conventionally mainstream, the display devices of thin-type flat panel displays (FPD) have come to be widely used. Among FPDs, there are FPDs that use liquid crystal, light-emitting diodes (LEDs), or organic electroluminescence (EL) or the like for display elements.

In these display devices, if an image including a checkered pattern arrangement is displayed, there is a large change between low pixel values and high pixel values (for example, between pixel values 0 and 255) between pixels that are adjacent above, below, to the left, or to the right. When this happens, there are a variety of negative effects on the display panel due to problems such as driving capability and center potential. One of these negative effects is flicker.

Flicker is a phenomenon where a screen blinks and flickering occurs, caused by fluctuations in brightness when a high pixel value and a low pixel value are applied. A checkered pattern arrangement is referred to as a flicker pattern, and this flicker occurs when a checkered pattern arrangement is displayed on a display panel.

Therefore, a scheme for mitigating flicker is disclosed in PTL 1. PTL 1 discloses a configuration in which reference correction data for minimizing flicker components in accordance with the gradation values of input image data is stored in advance for a plurality of reference coordinates on an image display region, and correction signals generated on the basis thereof are used to control the amplitude centered voltages of image signals. In-plane flicker components are thereby suppressed.

### CITATION LIST

### Patent Literature

PTL 1: Japanese Publication of Unexamined Patent Applications “Japanese Unexamined Patent Application Publication No. 2001-312242 (published on 9 Nov. 2001)”

### SUMMARY OF INVENTION

### Technical Problem

In the technology disclosed in PTL 1, if it is possible that flicker may occur, in-plane flicker components are suppressed by controlling the amplitude centered voltage of an image signal. However, there was no method for suppressing the generation of flicker by controlling the actual display of a flicker pattern when a specific flicker pattern that conventionally causes flicker to occur is to be displayed on a display panel.

Therefore, the present invention takes the aforementioned problem into consideration, and an objective thereof is to provide a display device and a display method therefor with which the generation of flicker can be suppressed when an image that includes a checkered pattern arrangement that is a flicker pattern is to be displayed.

### Solution to Problem

In order to solve the aforementioned problem, a display device according to a mode of the present invention is characterized by comprising: a detection unit that detects a flicker pattern having a checkered pattern arrangement included in an input image that has been input from outside; a conversion unit that, if the detection unit has detected the flicker pattern included in the input image, converts the input image into an output image that does not include the flicker pattern; and a display panel that displays the output image.

Furthermore, in order to solve the aforementioned problem, a display method according to a mode of the present invention is characterized by including: a detection step for detecting a flicker pattern having a checkered pattern arrangement included in an input image that has been input from outside; a conversion step for, if the flicker pattern has been detected in the input image in the detection step, converting the input image into an image that does not include the flicker pattern; and a display step for displaying the image obtained by the conversion in the conversion step.

According to the aforementioned configurations, an input image that includes a flicker pattern having a checkered pattern arrangement is converted into an image that does not include the flicker pattern, and an image that does not cause flicker to occur is output to a display panel. In this way, by converting an input image that includes a flicker pattern into an image that does not include the flicker pattern, the generation of flicker can be suppressed, and negative display effects that accompany the generation of flicker can be suppressed. Particularly in the present embodiments, because detection is performed as to whether or not a checkered pattern arrangement that is a flicker pattern that causes flicker to occur is included in an input image, the generation of flicker can almost certainly be suppressed, and the effect thereof is considerable.

Other objectives, features, and superior points of the present invention will be sufficiently comprehended from that disclosed hereafter. Furthermore, the advantages of the present invention will become apparent from the following description in which reference is made to the appended drawings.

### Advantageous Effects of Invention

According to the present invention, by converting an input image that includes a flicker pattern into an image that does not include the flicker pattern, the generation of flicker can be suppressed, and negative display effects that accompany the generation of flicker can be suppressed.

### BRIEF DESCRIPTION OF DRAWINGS

FIG. 1 is a drawing depicting a schematic configuration of a display device according to an embodiment of the present invention.

FIG. 2 is a drawing depicting an example of an image that includes a flicker pattern having a checkered pattern arrangement.

FIG. 3 is a drawing depicting an example of a spatial filter that is used when a flicker pattern included in an input image is detected in an embodiment of the present invention.

FIGS. 4 (a) to (c) are drawings that depict examples of 5×5 pixels and a spatial filter.

FIG. 5 (a) depicts a display method for when a flicker pattern is not included in an input image in an embodiment in the present invention, and FIG. 5 (b) depicts a display method for when a flicker pattern is included in an input image in an embodiment in the present invention.

FIG. 6 is a drawing depicting an image in which image processing according to an embodiment of the present invention has been performed.

FIG. 7 depicts another display method for when a flicker pattern is included in an input image in an embodiment in the present invention.

FIG. 8 is a drawing depicting an image in which other image processing according to an embodiment of the present invention has been performed.

FIG. 9 is a drawing depicting an example of a spatial filter that is used when a flicker pattern included in an input image is detected in an embodiment of the present invention.

FIG. 10 is a drawing depicting an example of a low-pass filter that is used when image processing is performed on an input image in an embodiment of the present invention.

FIGS. 11 (a) to (c) are drawings that depict other examples of low-pass filters that are used when image processing is performed on an input image in an embodiment of the present invention.

FIG. 12 is a drawing depicting an image in which image processing according to an embodiment of the present invention has been performed.

### DESCRIPTION OF EMBODIMENTS

Embodiments according to the present invention are described hereafter. It should be noted that although various preferable restrictions are applied in the following description in order to carry out the present invention, the technical scope of the present invention is not restricted to the following embodiments or drawings.

### First Embodiment

### (Overview of Display Device 1)

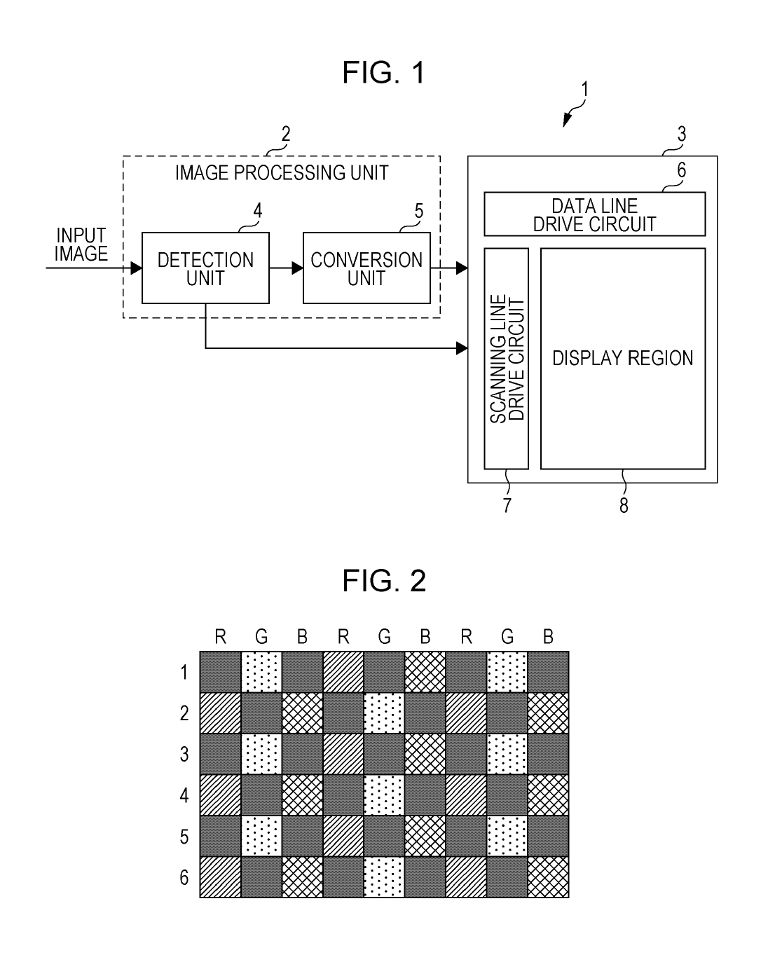

A display device according to the present invention is a display device that, if a flicker pattern having a checkered pattern arrangement such as that depicted in FIG. 2 is included in an image to be displayed, performs image processing on the aforementioned image, and thereby converts the image into an image that does not include the flicker pattern and displays the image. Hereafter, prior to describing a method for converting an image that includes a flicker pattern into an image that does not include the flicker pattern, the overall configuration of the display device according to the present invention is briefly described with reference to FIG. 1. FIG. 1 is drawing depicting a schematic configuration of a display device 1 according to the present embodiment.

As depicted in FIG. 1, the display device 1 is provided with an image processing unit 2, a display panel 3, and a controller that is not depicted. The display panel 3 includes various circuits, and is provided with a data line driving circuit 6 and a scanning line driving circuit 7.

The data line driving circuit 6 provided in the display panel 3 is a circuit that drives a plurality of data signal lines, and the scanning line driving circuit 7 is a circuit that drives a plurality of scanning signal lines. Various driving signals for driving the display panel 3 are supplied from the controller that is not depicted to the data line driving circuit 6 and the scanning line driving circuit 7.

In the controller that is not depicted, on the basis of a reference clock signal CLK, a horizontal synchronization signal Hsync, and a vertical synchronization signal Vsync that are input from outside, a data clock SCK and a data start pulse SSPB that are supplied to the data line driving circuit 6 are generated, and a gate clock GCK and a gate start pulse GSPB that are supplied to the scanning line driving circuit 7 are generated. It should be noted that the outside referred to here is a host such as a CPU that controls the driving of the display device 1.

Meanwhile, in the controller that is not depicted, the image data input from outside is output to the image processing unit 2. The image processing unit 2 is composed of a detection unit 4 and a conversion unit 5. The detection unit 4 detects a flicker pattern included in the image data input from the controller that is not depicted. When the detection unit 4 detects a flicker pattern included in the image data, in the conversion unit 5, image processing is performed on the aforementioned image, and the image is thereby converted into an image that does not include the flicker pattern. That image data is supplied to the display panel 3. However, if the detection unit 4 has not detected a flicker pattern included in the image data input from the controller that is not depicted, that image data is supplied as it is to the display panel 3.

In the display panel 3, the data line driving circuit 6 outputs a data signal based on the supplied image data, to the data signal lines at a timing based on the data clock SCK and the data start pulse SSPB. Likewise, the scanning line driving circuit 7 outputs a scanning signal based on the supplied image data, to the scanning signal lines at a timing based on the gate clock GCK and the gate start pulse GSPB. In this way, the image data input from outside is displayed in a display region 8 of the display panel 3.

As described above, if a checkered pattern arrangement that is a flicker pattern is included in an image to be displayed on the display panel 3, the display device 1 according to the present embodiment performs, in the image processing unit 2, conversion into an image that does not include the flicker pattern. Thus, if an image that includes a flicker pattern is to be displayed, the generation of flicker can be suppressed. Specific image processing in the image processing unit 2 is described hereafter.

### (Detection Processing of the Detection Unit 4)

Flicker pattern detection processing in the detection unit 4 of the image processing unit 2 is described first, and then image conversion processing in the conversion unit 5 is described.

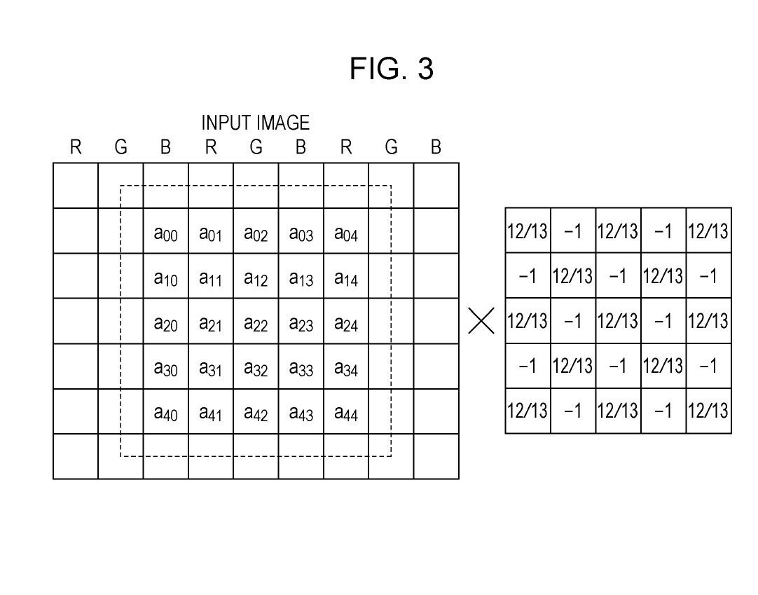

In the detection unit 4, whether or not a checkered pattern arrangement that is a flicker pattern is included in an input image is detected by means of spatial filtering. Spatial filtering is processing in which the pixel values of a specific pixel and the neighboring pixels thereof are used to perform a calculation with a filter. Specifically, when an input image such as that depicted in FIG. 3 for example is assumed, a product sum calculation with a 5×5 spatial filter in which coefficients such as those depicted in FIG. 3 have a checkered pattern arrangement is performed on 5×5 pixels centered on a target pixel a₂₂ (the region enclosed by a dotted line in the drawing). The specific calculation expression is represented by the following expression. It should be noted that, in the present drawing, one pixel is constituted by sub-pixels arranged side-by-side in the order of RGB, and S is obtained for the case where one of the sub- pixels is the target pixel a₂₂.

S=|12/13a₀₀−a₀₁+12/13a₀₂−. . . +12/13a₄₄| [Math. 1]

The aforementioned S is obtained for the cases where all of the sub-pixels of an input image serve as the target pixel a₂₂. In other words, the aforementioned S is obtained for all of the sub-pixels while the target pixel a₂₂ is scanned from the upper-left sub-pixel of the input image to the lower-right sub-pixel. A total value T for S is then calculated by means of the following expression.

T=ΣS [Math. 2]

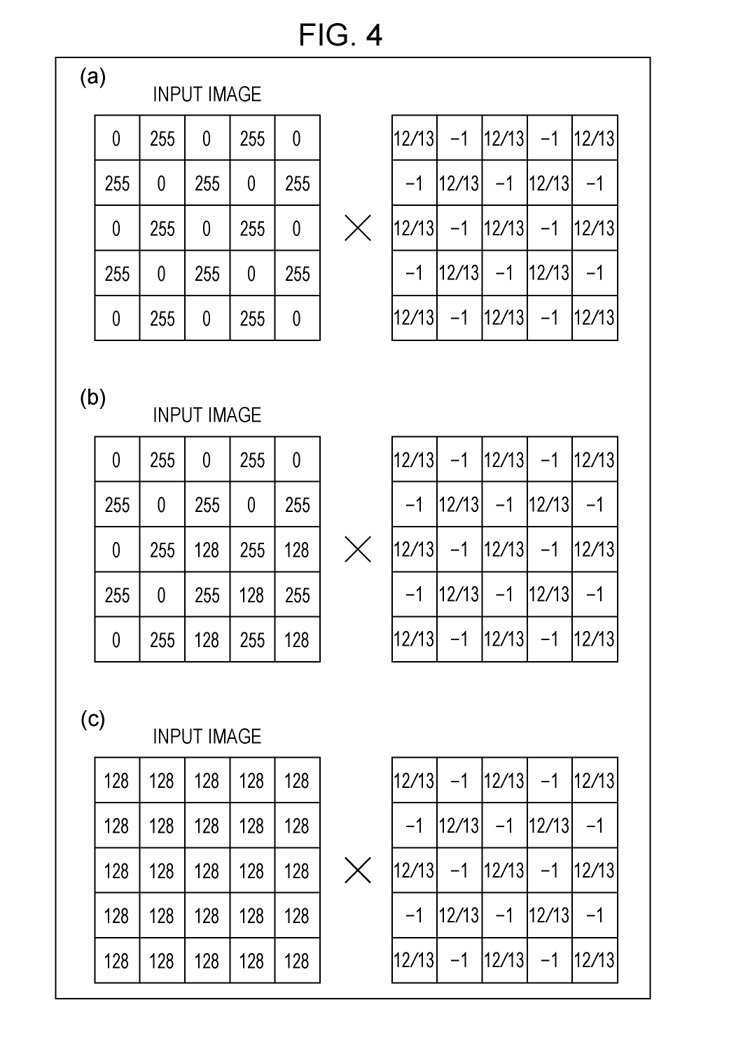

When the obtained T exceeds a predetermined threshold value, it is determined that a flicker pattern is included in the input image. The reason therefor is briefly described with reference to FIG. 4. FIGS. 4 (a) to (c) are drawings that depict examples of 5×5 pixels and a spatial filter.

FIG. 4 (a) depicts the case where a 5×5-pixel input image is a flicker pattern having a checkered pattern arrangement. In this case, because the filter coefficients (12/13, −1) of the spatial filter have a checkered pattern arrangement, when the pixel values of the input image also have a checkered pattern arrangement, S is the maximum. Consequently, S is 3060.

Meanwhile, FIG. 4 (b) depicts the case where part of a 5×5-pixel input image includes a flicker pattern having a checkered pattern arrangement. In this case, S is approximately 2469, which is a decrease compared to the case of FIG. 4 (a).

FIG. 4 (c) depicts the case where a 5×5-pixel input image is a solid image. In this case, S is 0, and S is the minimum. In this way, S is the maximum when the input image is a flicker pattern having a checkered pattern arrangement, and S decreases as the flicker pattern disappears from the input image.

If this is used, it is understood that the proportion of a flicker pattern taken up in the input image increases as the total value T of S obtained for all of the pixels of the input image increases. For example, if the input image is a flicker pattern, because S that is obtained for all of the pixels of the input image is the maximum, the total value T is also the maximum.

Therefore, if the threshold value for the total value T is predetermined, it can be determined that a flicker pattern is included in the input image if T exceeds the threshold value. Since the value of S is determined dependent upon the filter coefficients, it is necessary for the aforementioned threshold value for T to be determined by means of experimentation in consideration of the filter coefficients, the actual viewing method, and the resolution of the display device 1 and so forth.

Here, although two values are used for the filter coefficients, it is necessary for one to be a positive value and the other to be a negative value. In other words, in the spatial filter used in the present embodiment, two filter coefficients of a positive value and a negative value are arranged in a checkered pattern. Although there is no particular restriction to the specific numerical values thereof, it is preferable to use two values with which the total of the filter coefficients is 0. An example is a filter in which 12/13 and −1 are used for filter coefficients as depicted in FIG. 3, or a filter in which the opposites thereof, −12/13 and 1, are used. If the total of the filter coefficients is 0, S is the minimum value when the input image is a solid image; however, this minimum value is ordinarily 0 independent of the pixel values of the input image. Consequently, S being the maximum when the input image is a flicker pattern having a checkered pattern arrangement, and S being the minimum (0) when the input image is a solid image can ordinarily be realized. However, if the total of the filter coefficients is not 0, S is not always the minimum when the input image is a solid image. Thus, it is preferable for the total of the flicker coefficients to be 0.

Furthermore, it is preferable for the absolute values of the two values used for the filter coefficients to be as equal as possible. If there is a difference in the absolute values of the two values used for the filter coefficients, there are cases where, due to those values, S is not the maximum even when the input image is a flicker pattern having a checkered pattern arrangement. Thus, although it is preferable for the absolute values of the two values used for the filter coefficients to be as equal as possible, it is preferable to use values with which S being the maximum when the input image is a flicker pattern can be realized, even when filter coefficients with which there is a difference in the absolute values of the two values are used.

Incidentally, the spatial filter is not restricted to a 5×5 filter. For example, a 3×3 filter is also permissible, and a 7×7 or 9×9 filter is also permissible. However, a 3×3 filter is not preferable as there is a drop in accuracy. Conversely, there is an increase in accuracy with a 7×7 or 9×9 filter; however, there is an increase in cost in terms of equipment. Therefore, if these points are taken into consideration, it is preferable to use a 5×5 filter as the spatial filter.

### (Image Conversion Processing (1) of the Conversion Unit 5)

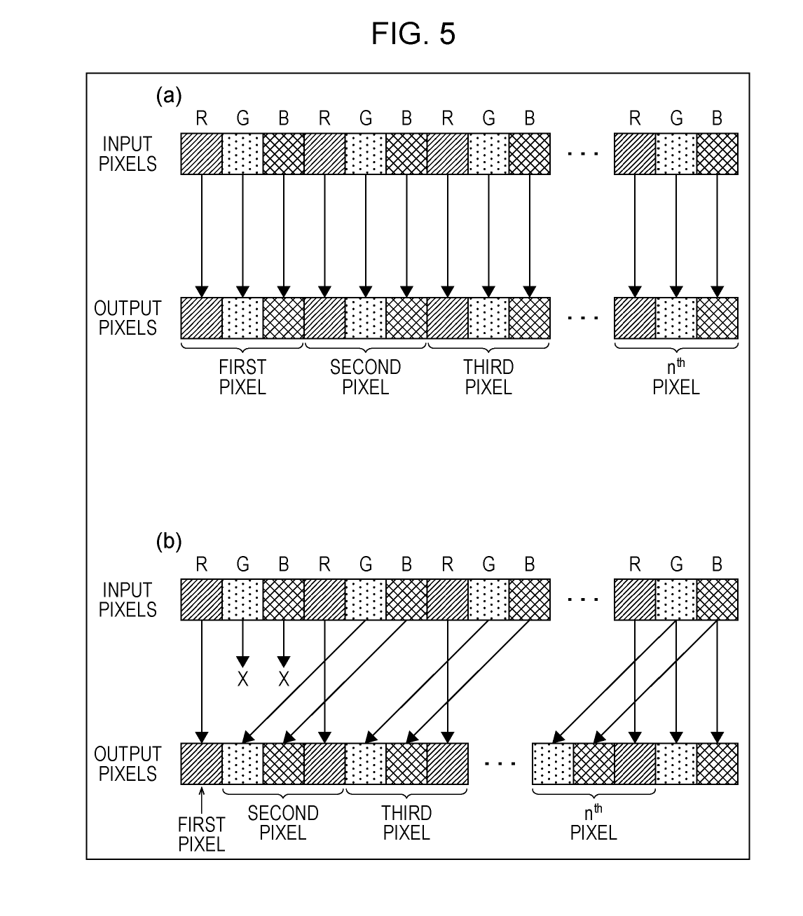

In the conversion unit 5, if it is determined in the detection unit 4 that a flicker pattern is included in the input image, the pixel arrangement of the input image is changed, and the input image is thereby converted into an image that does not contain the flicker pattern. The specific method is described with reference to FIG. 5. FIG. 5 (a) depicts a display method for when a flicker pattern is not included in an input image, and FIG. 5 (b) depicts a display method for when a flicker pattern is included in an input image. In the present drawings, one pixel is constituted by sub-pixels (a first sub-pixel, a second sub-pixel, and a third sub-pixel) arranged side-by-side in the order of RGB. Furthermore, the pixel rows depicted in the present drawings are an arbitrary pixel row in an input image and a pixel row in an output image corresponding thereto.

First, if the detection unit 4 has determined that a flicker pattern is not included in the input image, the image data of the input image is supplied as it is to the display panel 3. In other words, when focusing on the pixel arrangements of the arbitrary pixel row of the input image and the pixel row corresponding to said pixel row in an output image output from the display panel 3, as depicted in FIG. 5 (a), the first pixel of the input image is output as the first pixel of the output image, and the second pixel of the input image is output as the second pixel of the output image. Then, pixels up to an n^{th} pixel thereafter are also similarly output, and there is no change between the pixel arrangement of the input image and the pixel arrangement of the output image. In other words, the sub-pixels from one end side of the pixel row in the output image to the other end side have the pixel values of the sub-pixels from the one end side of the pixel row in the input image to the other end side. Consequently, in the display panel 3, the image data from the detection unit 4 is displayed as it is.

However, if the detection unit 4 has determined that a flicker pattern is included in the input image, the image data of the input image is supplied to the conversion unit 5. In this case, the pixel arrangement of the input image is altered in the conversion unit 5. Specifically, as depicted in FIG. 5 (b), a pixel row of the input image is rearranged so that one pixel is constituted by sub-pixels arranged side-by-side in the order of GBR. Due to the pixel row of the input image being rearranged in such a way that one pixel is constituted by sub-pixels arranged side-by-side in the order of GBR, only the sub-pixel R forming part of the first pixel of the input image is output as the sub-pixel R of the first pixel of the output image, and the other sub-pixels G and B are discarded. Consequently, the sub-pixel R of the first pixel of the input image is output for the sub-pixel R of the first pixel of the output image, and the sub-pixels constituting the second pixel of the input image are rearranged into the order of GBR and output for the second pixel adjacent to the first pixel of the output image. When the pixel row thereafter is similarly rearranged and output, the last two sub-pixels (a sub-pixel G and a sub-pixel B) in the pixel row of the output image remain. Therefore, those two sub-pixels are supplemented by outputting the sub-pixel G and the sub-pixel B of the n^{th} pixel of the input image.

In other words, the first one sub-pixel R at one end side in the pixel row of the output image is set to have the pixel value of the first sub-pixel R at the one end side in the pixel row of the input image, and the last two sub-pixels G and B at the other end side in the pixel row of the output image are set to have the pixel values of the last two sub-pixels G and B at the other end side in the pixel row of the input image. Then, the sub-pixels between the first one sub-pixel R at the one end side in the pixel row of the output image and the last two sub-pixels G and B at the other end side are set to have pixel values obtained by rearranging the sub-pixels constituting, in order from the one end side, from the second pixel at the one end side in the pixel row of the input image to the last pixel at the other end side, into the order of sub-pixel G, sub-pixel B, and sub-pixel R for each of the aforementioned pixels.

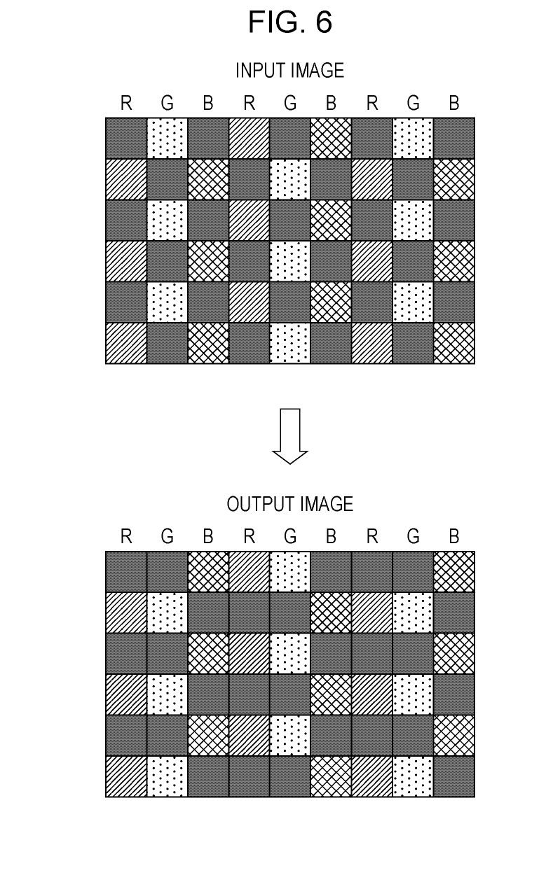

The aforementioned processing is performed on all of the pixel rows of the input image, and an output image in which the pixel arrangement has been rearranged is generated. The image data of the generated output image is supplied to the display panel 3 and displayed. As a result, as depicted in FIG. 6, an input image that includes a flicker pattern having a checkered pattern arrangement is converted into an output image that does not include the flicker pattern, and an image that does not cause flicker to occur is output to the display panel 3. In this way, by rearranging the pixel arrangement of an input image that includes a flicker pattern and converting the input image into an output image that does not include the flicker pattern, the generation of flicker can be suppressed, and negative display effects that accompany the generation of flicker can be suppressed. Particularly in the present embodiment, because detection is performed as to whether or not a checkered pattern arrangement that is a flicker pattern that causes flicker to occur is included in an input image, the generation of flicker can almost certainly be suppressed, and the effect thereof is considerable. At such time, because the number of pixels per unit area in the output image has not changed from the input image, there are no changes in brightness or tone or the like due to rearranging the pixel arrangement, and there are no adverse effects due to the image conversion processing.

It should be noted that although an example in which one pixel is constituted by sub-pixels arranged side-by-side in the order of RGB has been given above, the present embodiment is by no means restricted to this. For example one pixel may be constituted by sub-pixels arranged side-by-side in the order of BRG or in the order of GBR.

### (Image Conversion Processing (2) of the Conversion Unit 5)

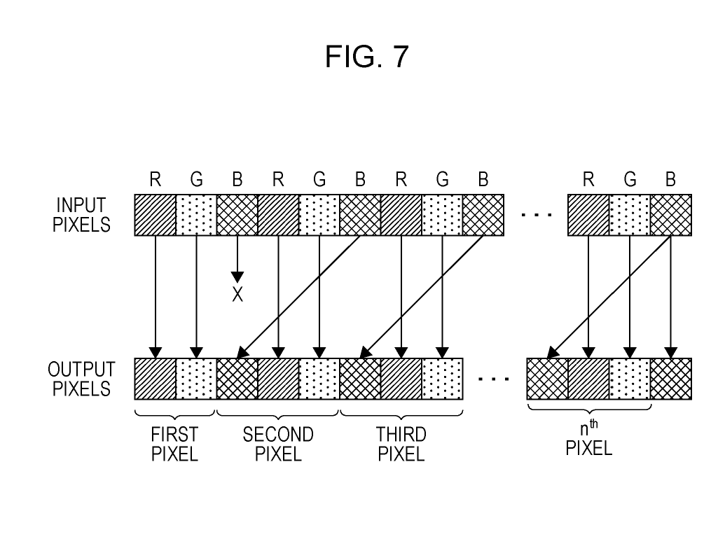

Although an example in which a pixel row of an input image is rearranged so that one pixel is constituted by sub-pixels arranged side-by-side in the order of GBR has been given above, the present embodiment is by no means necessarily restricted to this. For example, a pixel row of the input image may be rearranged so that one pixel is constituted by sub-pixels arranged side-by-side in the order of BRG. The specific method is described with reference to FIG. 7. FIG. 7 depicts another display method for when a flicker pattern is included in an input image. In the present drawing, one pixel is constituted by sub-pixels (a first sub-pixel, a second sub-pixel, and a third sub-pixel) arranged side-by-side in the order of RGB. Furthermore, the pixel rows depicted in the present drawing are an arbitrary pixel row in an input image and a pixel row in an output image corresponding thereto.

If the detection unit 4 has determined that a flicker pattern is included in an input image, the image data of the input image is supplied to the conversion unit 5. In this case, the pixel arrangement of the input image is altered in the conversion unit 5. Specifically, as depicted in FIG. 7, a pixel row of the input image is rearranged so that one pixel is constituted by sub-pixels arranged side-by-side in the order of BRG. Due to the pixel rows of the input image being rearranged in such a way that one pixel is constituted by sub-pixels arranged side-by-side in the order of BRG, only the sub-pixel R and the sub-pixel G forming part of the first pixel of the input image are output as the sub-pixel R and the sub-pixel G of the first pixel of the output image, and the other sub-pixel B is discarded. Consequently, the sub-pixel R and the sub-pixel G of the first pixel of the input image are output for the sub-pixel R and the sub-pixel G of the first pixel of the output image, and the sub-pixels constituting the second pixel of the input image are rearranged into the order of BGR and output for the second pixel adjacent to the first pixel of the output image. When the pixel row thereafter is similarly rearranged and output, the last one sub-pixel B in the pixel row of the output image remains. Therefore, that one sub-pixel is supplemented by outputting the sub-pixel B of the n^{th} pixel of the input image.

In other words, the first two sub-pixels (sub-pixel R and sub-pixel G) at one end side in the pixel row of the output image are set to have the pixel values of the first sub-pixel R and sub-pixel G at the one end side in the pixel row of the input image, and the last one sub-pixel B at the other end side in the pixel row of the output image is set to have the pixel value of the last one sub-pixel B at the other end side in the pixel row of the input image. Then, the sub-pixels between the first sub-pixel R and sub-pixel G at the one end side in the pixel row of the output image and the last one sub-pixel B at the other end side are set to have pixel values obtained by rearranging the sub-pixels constituting, in order from the one end side, from the second pixel at the one end side in the pixel row of the input image to the last pixel at the other end side, into the order of sub-pixel B, sub-pixel R, and sub-pixel G for each of the aforementioned pixels.

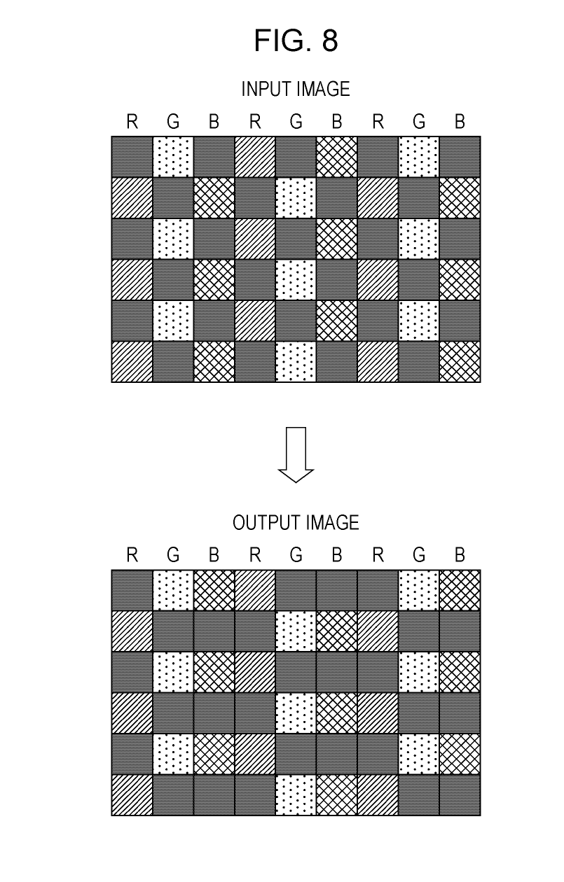

The aforementioned processing is performed on all of the pixel rows of the input image, and an output image in which the pixel arrangement has been rearranged is generated. The image data of the generated output image is supplied to the display panel 3 and displayed. As a result, as depicted in FIG. 8, an input image that includes a flicker pattern having a checkered pattern arrangement is converted into an output image that does not include the flicker pattern, and an image that does not cause flicker to occur is output to the display panel 3.

By using this kind of method, it is also possible to convert an input image that includes a flicker pattern, into an output image that does not include a flicker pattern. In this case also, the generation of flicker can be suppressed, and negative display effects that accompany the generation of flicker can be suppressed. Furthermore, because the number of pixels per unit area in the output image has not changed from the input image, there are no changes in brightness or tone or the like due to rearranging the pixel arrangement, and there are no adverse effects due to the image conversion processing.

### Second Embodiment

### (Detection Processing of the Detection Unit 4)

In the first embodiment, if it is determined in the detection unit 4 that a flicker pattern is included in an input image, the conversion unit 5 changes the pixel arrangement of the input image, and the input image is thereby converted into an image that does not contain the flicker pattern; however, the present invention is by no means restricted to this. Therefore, in the present embodiment, if a checkered pattern arrangement that is a flicker pattern is included in an input image, conversion is performed in the image processing unit 2 into an image that does not include the flicker pattern, by means of a method that is different from the first embodiment. That method is described below.

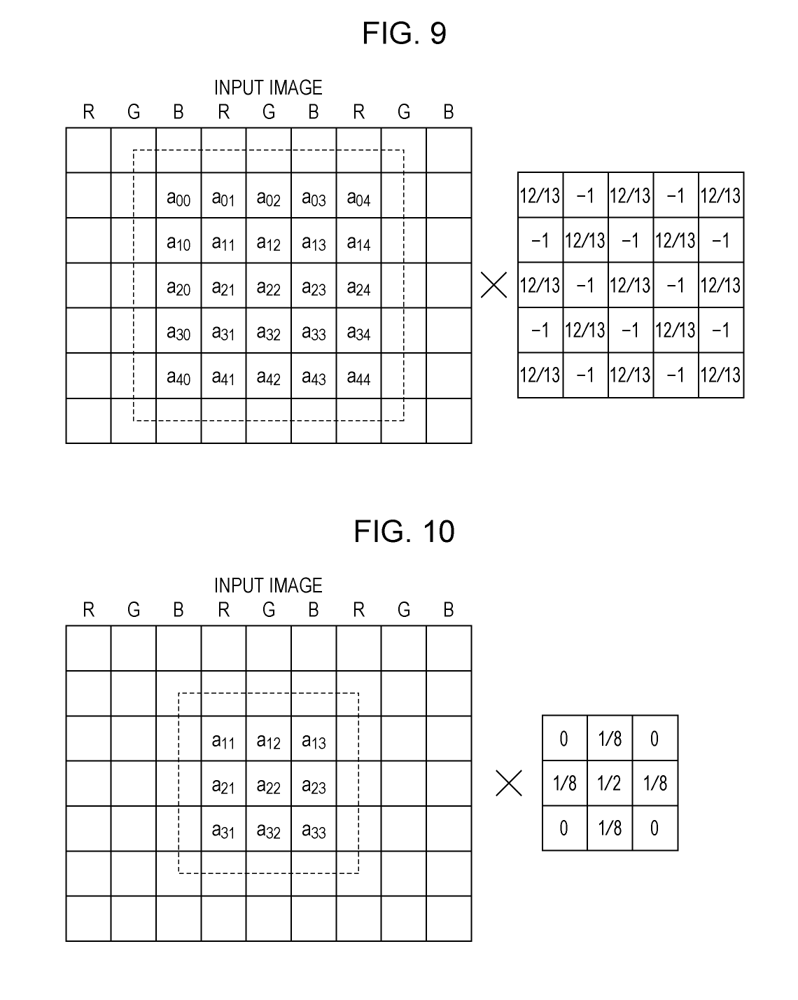

In the detection unit 4, whether or not a checkered pattern arrangement that is a flicker pattern is included in an input image is detected by means of spatial filtering. Specifically, when an input image such as that depicted in FIG. 9 for example is assumed, a product sum calculation with a 5×5 spatial filter in which coefficients such as those depicted in FIG. 9 have a checkered pattern arrangement is performed on 5×5 pixels centered on a target pixel a₂₂ (the region enclosed by a dotted line in the drawing). The specific calculation expression is represented by the following expression. It should be noted that, in the present drawing, one pixel is constituted by sub-pixels arranged side-by-side in the order of RGB, and S is obtained for the case where one of the sub-pixels is the target pixel a₂₂.

S=|12/13a₀₀−a₀₁+12/13a₀₂−. . . +12/13a₄₄| [Math. 3]

When S obtained for a target pixel a₂₂ exceeds a predetermined threshold value, it is determined that a flicker pattern is present in the 5×5 pixels centered on the target pixel a₂₂ (in other words, a target region for spatial filtering). The aforementioned S is obtained for the cases where all of the sub-pixels of the input image serve as the target pixel a₂₂, and it is determined whether or not each S exceeds the predetermined threshold value. In other words, the aforementioned S is obtained for all of the sub-pixels while the target pixel a₂₂ is scanned from the upper-left sub-pixel of the input image to the lower-right sub-pixel, and it is determined whether or not the predetermined threshold value is exceeded.

The reason for determining that a flicker pattern is present in 5×5 pixels centered on an arbitrary target pixel a₂₂ when S obtained for the target pixel a₂₂ exceeds the predetermined threshold value is as mentioned in the first embodiment; in other words, because the filter coefficients (12/13, −1) of the spatial filter have a checkered pattern arrangement, and because S is the maximum when the 5×5 pixels centered on the target pixel a₂₂ are a flicker pattern having a checkered pattern arrangement, and S decreases as the flicker pattern disappears from the input image.

If this is used, it is understood that the proportion of the flicker pattern taken up in the 5×5 pixels centered on the target pixel a₂₂ increases as S obtained for the target pixel a₂₂ increases. Therefore, if a threshold value for S is predetermined, it can be determined that a flicker pattern is present in the 5×5 pixels centered on the target pixel a₂₂ when S exceeds the threshold value. Since the value of S is determined dependent upon the filter coefficients, it is necessary for the threshold value for S to be experimentally determined in consideration of filter coefficients and the actual viewing method and so forth.

Here, although two values are used for the filter coefficients as in the first embodiment, it is necessary for one to be a positive value and the other to be a negative value. In other words, in the spatial filter used in the present embodiment, two filter coefficients of a positive value and a negative value are arranged in a checkered pattern. Although there is no particular restriction to the specific numerical values thereof, it is preferable to use two values with which the total of the filter coefficients is 0. An example is a filter in which 12/13 and −1 are used for filter coefficients as depicted in FIG. 9, or a filter in which the opposites thereof, −12/13 and 1, are used. If the total of the filter coefficients is 0, S is the minimum value when the input image is a solid image; however, this minimum value is ordinarily 0 independent of the pixel values of the input image. Consequently, S being the maximum when the input image is a flicker pattern having a checkered pattern arrangement, and S being the minimum (0) when the input image is a solid image can ordinarily be realized. However, if the total of the filter coefficients is not 0, S is not always the minimum when the input image is a solid image. Thus, it is preferable for the total of the flicker coefficients to be 0.

Furthermore, it is preferable for the absolute values of the two values used for the filter coefficients to be as equal as possible. If there is a difference in the absolute values of the two values used for the filter coefficients, there are cases where, due to those values, S is not the maximum even when the input image is a flicker pattern having a checkered pattern arrangement. Thus, although it is preferable for the absolute values of the two values used for the filter coefficients to be as equal as possible, it is preferable to use values with which S being the maximum when the input image is a flicker pattern can be realized, even when filter coefficients with which there is a difference in the absolute values of the two values are used.

Incidentally, the spatial filter is not restricted to a 5×5 filter. For example, a 3×3 filter is also permissible, and a 7×7 or 9×9 filter is also permissible. However, a 3×3 filter is not preferable as there is a drop in accuracy.

Conversely, there is an increase in accuracy with a 7×7 or 9×9 filter; however, there is an increase in cost in terms of equipment. Therefore, if these points are taken into consideration, it is preferable to use a 5×5 filter as the spatial filter.

### (Image Conversion Processing of the Conversion Unit 5)

In the conversion unit 5, low-pass filter processing is performed for pixels in which it has been determined in the detection unit 4 that a flicker pattern is present, and the input image is thereby converted into an image that does not contain the flicker pattern. Specifically, when a sub-pixel in the center of a target region in which it has been determined that a flicker pattern is present is set as a target pixel a₂₂, as depicted in FIG. 10, a product sum calculation with a 3×3 low-pass filter in which filter coefficients have a checkered pattern arrangement is performed on 3×3 pixels centered on the target pixel a₂₂ (the region enclosed by a dotted line in the drawing). The specific calculation expression is represented by the following expression.

a₂₂′=0·a₁₁+⅛a₁₂+0·a₁₃+. . . +⅛a₃₂+0·a₃₃ [Math. 4]

By applying a low-pass filter, the difference between the pixel values of the sub-pixels decreases. In other words, by applying the low-pass filter, a blurred image is obtained. In the present embodiment, this is used for conversion into an image that does not include a flicker pattern. It should be noted that there is no particular restriction to the filter coefficients of the low-pass filter or the arrangement thereof. For example, a low-pass filter having filter coefficients such as those depicted in FIGS. 11 (a) to (c) may be used.

In the case of the low-pass filter depicted in FIG. 11 (a), the weighting for the target pixel (the sub-pixel in the center) is 1/9, and the weighting for the neighboring sub-pixels surrounding the target pixel is also 1/9. In this case, the resulting image blurs even when the same weighting is applied to the target pixel and the neighboring sub-pixels thereof, and therefore there are no problems. In the case of this low-pass filter, the blurring of the image is considerable.

Furthermore, in the case of the low-pass filter depicted in FIG. 11 (b), the weighting for the target pixel is increased to ¾, and the weighting for the neighboring sub-pixels is reduced to 1/16. In this case, the weighting for the target pixel is increased, but the weighting for the neighboring sub-pixels thereof is reduced, and the blurring of the image is therefore reduced.

In the case of the low-pass filter depicted in FIG. 11 (c), the weighting for the target pixel is ½, and a weighting of ¼ is applied to only the sub-pixels on either side of the target pixel. This is effective in the case where it is has been experimentally understood that flicker does not occur if blurring is applied in only the horizontal direction of the image. Conversely, in the case where it is has been experimentally understood that flicker does not occur if blurring is applied in only the vertical direction of the image, a low-pass filter such as the low-pass filter depicted in the present drawing that has been rotated by 90° is effective.

In this way, the filter coefficients of a low-pass filter and the arrangement thereof should be experimentally determined in consideration of the extent to which an image is to be blurred and which location in the image is to be selectively blurred by applying the low-pass filter.

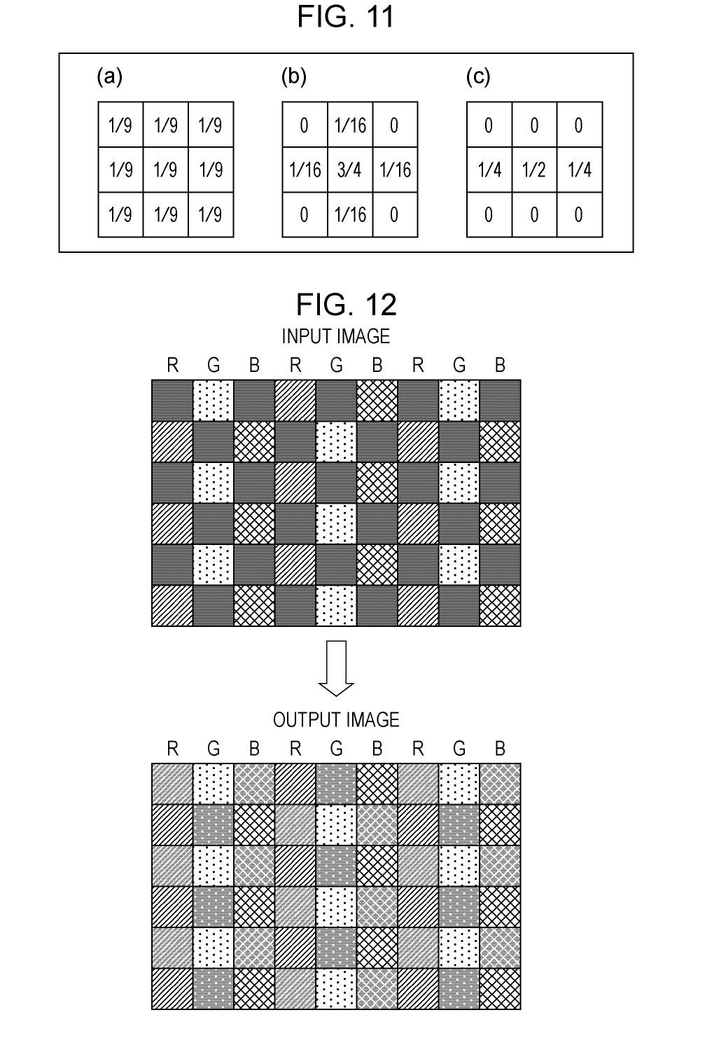

a₂₂′, which is obtained in the manner described above, is replaced with the pixel value of the target pixel a₂₂. This processing is performed for the sub-pixel in the center of all target regions in which it has been determined by the detection unit 4 that a flicker pattern is present, and an image in which those pixel values have been replaced with new pixel values is generated. It should be noted that the pixel values of the sub-pixels in the center of target regions in which it has been determined that a flicker pattern is not present are used as they are. The image data of the generated output image is supplied to the display panel 3 and displayed. As a result, as depicted in FIG. 12, an input image that includes a flicker pattern having a checkered pattern arrangement is converted into an output image that does not include the flicker pattern, and an image that does not cause flicker to occur is output to the display panel 3. In this way, by replacing the pixel value of the sub-pixel in the center of a target region in which a flicker pattern is present and performing conversion into an image that does not include the flicker pattern, the generation of flicker can be suppressed, and negative display effects that accompany the generation of flicker can be suppressed. Particularly in the present embodiment, because detection is performed as to whether or not a checkered pattern arrangement that is a flicker pattern that causes flicker to occur is included in an input image, the generation of flicker can almost certainly be suppressed, and the effect thereof is considerable.

Furthermore, although the image processing according to the first embodiment is applied in the case where one pixel is configured from three sub-pixels of RGB, it is possible for the image processing according to the present embodiment to also be applied in the case where one pixel is configured from four or more sub-pixels, and to also be applied in the case where the display device 1 performs monochrome display.

The present invention is not limited to the aforementioned embodiments, and a variety of alterations are possible within the scope indicated in the claims. In other words, embodiments obtained by combining technical means appropriately altered within the scope indicated in the claims are also included in the technical scope of the present invention.

### [Overview of Embodiments]

As described above, in order to solve the aforementioned problem, a display device according to a mode of the present invention is characterized by comprising: a detection unit that detects a flicker pattern having a checkered pattern arrangement included in an input image that has been input from outside; a conversion unit that, if the detection unit has detected the flicker pattern included in the input image, converts the input image into an output image that does not include the flicker pattern; and a display panel that displays the output image.

Furthermore, in order to solve the aforementioned problem, a display method according to a mode of the present invention is characterized by including: a detection step for detecting a flicker pattern having a checkered pattern arrangement included in an input image that has been input from outside; a conversion step for, if the flicker pattern has been detected in the input image in the detection step, converting the input image into an image that does not include the flicker pattern; and a display step for displaying the image obtained by the conversion in the conversion step.

According to the aforementioned configurations, an input image that includes a flicker pattern having a checkered pattern arrangement is converted into an image that does not include the flicker pattern, and an image that does not cause flicker to occur is output to a display panel. In this way, by converting an input image that includes a flicker pattern into an image that does not include the flicker pattern, the generation of flicker can be suppressed, and negative display effects that accompany the generation of flicker can be suppressed. Particularly in the present embodiments, because detection is performed as to whether or not a checkered pattern arrangement that is a flicker pattern that causes flicker to occur is included in an input image, the generation of flicker can almost certainly be suppressed, and the effect thereof is considerable.

Furthermore, in a display device according to a mode of the present invention, pixels constituting the input image are characterized by each being composed of sub-pixels arranged side-by-side in the order of a first sub-pixel, a second sub-pixel, and a third sub-pixel, and the detection unit is characterized by performing, with respect to all of the first sub-pixels, the second sub-pixels, and the third sub-pixels, spatial filtering using a filter in which two filter coefficients of a positive value and a negative value are arranged in a checkered pattern, and if a total value of values obtained by means of the spatial filtering exceeds a predetermined threshold value, determining that the flicker pattern included in the input image has been detected.

Furthermore, in a display device according to a mode of the present invention, the conversion unit is characterized by converting the input image into the output image in which, for each pixel row of the input image, the first one of the sub-pixels at one end side in a pixel row corresponding in the output image to the pixel row in question of the input image is set to have the pixel value of the first of the sub-pixels at the one end side in the pixel row of the input image, the last two of the sub-pixels at the other end side in the pixel row corresponding in the output image to the pixel row of the input image are set to have the pixel values of the last two of the sub-pixels at the other end side in the pixel row of the input image, and the sub-pixels between the first one of the sub-pixels at the one end side in the pixel row corresponding in the output image to the pixel row of the input image and the last two of the sub-pixels at the other end side are set to have pixel values obtained by rearranging the sub-pixels constituting, in order from the one end side, from the second of the pixels at the one end side in the pixel row of the input image to the last of the pixels at the other end side, into the order of the second sub-pixel, the third sub-pixel, and the first sub-pixel for each of the pixels.

Furthermore, in a display device according to a mode of the present invention, the conversion unit is characterized by converting the input image into the output image in which, for each pixel row of the input image, the first two of the sub-pixels at one end side in a pixel row corresponding in the output image to the pixel row in question of the input image is set to have the pixel values of the first two of the sub-pixels at the one end side in the pixel row of the input image, the last one of the sub-pixels at the other end side in the pixel row corresponding in the output image to the pixel row of the input image is set to have the pixel value of the last one of the sub-pixels at the other end side in the pixel row of the input image, and the sub-pixels between the first two of the sub-pixels at the one end side in the pixel row corresponding in the output image to the pixel row of the input image and the last one of the sub-pixels at the other end side are set to have pixel values obtained by rearranging the sub-pixels constituting, in order from the one end side, from the second of the pixels at the one end side in the pixel row of the input image to the last of the pixels at the other end side, into the order of the third sub-pixel, the first sub-pixel, and the second sub-pixel for each of the pixels.

According to the aforementioned configurations, by rearranging the pixel arrangement of an input image that includes a flicker pattern and converting the input image into an image that does not include the flicker pattern, the generation of flicker can be suppressed, and negative display effects that accompany the generation of flicker can be suppressed. At such time, because the number of pixels per unit area in the output image has not changed from the input image, there are no changes in brightness or tone or the like due to rearranging the pixel arrangement, and there are no adverse effects due to the image conversion processing.

Furthermore, in a display device according to a mode of the present invention, the detection unit is characterized by performing, with respect to the sub-pixels constituting the pixels constituting the input image, spatial filtering using a filter in which two filter coefficients of a positive value and a negative value are arranged in a checkered pattern, and determining that the flicker pattern included in the input image has been detected if a value obtained by means of the spatial filtering exceeds a predetermined threshold value in at least one of the sub-pixels.

Furthermore, in a display device according to a mode of the present invention, the conversion unit is characterized by converting the input image into the output image in which the pixel value of the sub-pixel for which a value obtained by means of the spatial filtering exceeds the predetermined threshold value is replaced with a pixel value obtained by performing low-pass filter processing on the sub-pixel.

According to the aforementioned configurations, by replacing the pixel values of an input image in which a flicker pattern is present and performing conversion into an image that does not include the flicker pattern, the generation of flicker can be suppressed, and negative display effects that accompany the generation of flicker can be suppressed.

The specific embodiments or examples given in the section of the detailed description of the invention are, at most, for clarifying the technical content of the present invention, are not to be interpreted in a narrow manner restricted only to such specific examples, and can be carried out with various alterations within the spirit of the present invention and the scope of the claims disclosed hereafter.

### INDUSTRIAL APPLICABILITY

The present invention may be suitably used in display devices of electronic equipment such as mobile telephones, PDAs (personal digital assistants), mobile game consoles, and personal computers.

### Reference Signs List

1 Display device
2 Image processing unit
3 Display panel
4 Detection unit
5 Conversion unit
6 Data line driving circuit
7 Scanning line driving circuit
8 Display region

1. A display device comprising:
a detection unit to detect a flicker pattern having a checkered pattern arrangement included in an input image that has been input from outside, pixels constituting the input image being each composed of sub-pixels arranged side-by-side in the order of a first sub-pixel, a second sub-pixel, and a third sub-pixel;
a conversion unit to, if the detection unit has detected the flicker pattern included in the input image, convert the input image into an output image in which, for each pixel row of the input image, the sub-pixels constituting the nth pixel of the pixel row (n is a natural number not smaller than 2 but not greater than the number of the pixels in the pixel row) are rearranged in the order of the second sub-pixel of the n^{th} pixel, the third sub-pixel of the n^{th} pixel, and the first sub-pixel of the n^{th} pixel; and
a display panel to display the output image.

2. The display device according to claim 1, wherein
the detection unit performs, with respect to all of the first sub-pixels, the second sub-pixels, and the third sub-pixels of the input image, spatial filtering using a filter in which two filter coefficients of a positive value and a negative value are arranged in a checkered pattern, and if a total value of values obtained by means of the spatial filtering exceeds a predetermined threshold value, determines that the flicker pattern included in the input image has been detected.

3-7. (canceled)

8. A display device comprising:
a detection unit to detect a flicker pattern having a checkered pattern arrangement included in an input image that has been input from outside, pixels constituting the input image being each composed of sub-pixels arranged side-by-side in the order of a first sub-pixel, a second sub-pixel, and a third sub-pixel;
a conversion unit to, if the detection unit has detected the flicker pattern included in the input image, convert the input image into an output image in which, for each pixel row of the input image, sub-pixels constituting the n^{th} pixel of the pixel row (n is a natural number not smaller than 2 but not greater than the number of the pixels in the pixel row) are rearranged in the order of the third sub-pixel of the n^{th} pixel, the first sub-pixel of the nth pixel, and the second sub-pixel of the n^{th} pixel; and
a display panel to display the output image.

9. The display device according to claim 8, wherein the detection unit performs, with respect to all of the first sub-pixels, the second sub-pixels, and the third sub-pixels of the input image, spatial filtering using a filter in which two filter coefficients of a positive value and a negative value are arranged in a checkered pattern, and if a total value of values obtained by means of the spatial filtering exceeds a predetermined threshold value, determines that the flicker pattern included in the input image has been detected.
